(19) United States
(12) Patent Application Publication
(10) Pub. No.: US 2026/0095808 A1
(43) Pub. Date: Apr. 2, 2026

(54) TRANSMITTING BUFFER STATUS REPORTS IN WIRELESS NETWORKS IN THE PRESENCE OF CONFIGURED GRANTS

(71) Applicant: Apple Inc., Cupertino, CA (US)

(72) Inventors: Parisa Babaheidarian, Saratoga, CA (US); Darshan Bharat Ashar, San Jose, CA (US); Denis Yusim, Sunnyvale, CA (US); Dhruv Khati, San Jose, CA (US); Gopichand Movva, San Diego, CA (US); Vijay Venkataraman, San Jose, CA (US)

(21) Appl. No.: 18/899,867

(22) Filed: Sep. 27, 2024

(51) Int. Cl. H04W 28/02; H04W 72/21

(52) U.S. Cl. CPC H04W 28/0278; H04W 72/21

(57) ABSTRACT

Disclosed are methods, systems, and computer-readable medium to perform operations including: identifying data for transmission to a network, the data being associated with a Logical Channel Identifier (LCID); determining that a Buffer Status Report (BSR) corresponding to the data is pending; and in response to the determination: determining whether an Uplink Shared Channel (UL-SCH) resource is available for transmitting the BSR to the network; determining whether the LCID is associated with a logicalChannelSR-Mask parameter; and based these determinations, performing at least one of: (i) transmitting the BSR to the network using a grant associated with the UL-SCH, (ii) canceling a pendency of the BSR, or (iii) transmitting a Scheduling Request (SR) to the network.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the ETSI Third Generation Partnership Project (3GPP). The wireless communication networks facilitate mobile broadband service using technologies such as orthogonal frequency-division multiple access (OFDMA), multiple input multiple output (MIMO), advanced channel coding, massive MIMO, beamforming, and/or other features.

### SUMMARY

In general, a user equipment (UE) can transmit data to and/or receive data from a wireless network using a Configured Grant process, whereby the wireless network (e.g., via an access node such as a base station in the radio access network, RAN) allocates resources to the UE for data transmission and/or data reception. As an example, a UE can send a request to the wireless network for resources to transmit data (e.g., a Scheduling Request). In response, the wireless network can allocate resources to the UE based network conditions and/or other factors, and signal the allocated resources to the UE. In turn, the UE can transmit the data using the allocated resource (e.g., including Configured Grants and dynamic grants), in accordance with the signaled parameters.

In some implementations, a UE can also selectively transmit a Buffer Status Report (BSR) to the wireless network to facilitate the transmission of data. Based on the BSR, the wireless network can make an informed decision regarding uplink scheduling and resource allocation, such that the wireless network can better manage overall system capacity and facilitate the transmission of data in a timely manner.

As described in further detail below, the UE can be configured with mechanisms to selectively transmit BSRs and/or SRs to the network to facilitate the timely transmission of data. In some implementations, the techniques described herein can be beneficial in reducing data stall associated with uplink transmissions. These techniques may be particularly beneficial in the context of transmitting high priority and/or time-sensitive data, such as data associated with voice calls, videos calls, and/or interactive live content feeds.

In accordance with one aspect of the present disclosure, a method includes identifying data for transmission to a network, where the data is associated with a Logical Channel Identifier (LCID); determining that a Buffer Status Report (BSR) corresponding to the data is pending; and in response to determining that the BSR corresponding to the data is pending: determining whether an Uplink Shared Channel (UL-SCH) resource is available for transmitting the BSR to the network; determining whether the LCID is associated with a logicalChannelSR-Mask parameter; and based on the determination whether the UL-SCH resource is available for transmitting the BSR to the network and the determination whether the LCID is associated with the logicalChannelSR-Mask parameter, performing at least one of: transmitting the BSR to the network using a grant associated with the UL-SCH, canceling a pendency of the BSR, or transmitting a Scheduling Request (SR) to the network.

Implementations of this aspect can include or more of the following features.

In some implementations, the method can further include: determining that (i) the UL-SCH is available for transmitting the BSR to the network and (ii) the UL-SCH resource is not a configured resource; and in response to determining that (i) the UL-SCH is available for transmitting the BSR to the network and (ii) the UL-SCH resource is not a configured resource, transmitting the BSR to the network using the grant and canceling the pendency of the BSR.

In some implementations, the method can further include: determining that (i) the UL-SCH is available for transmitting the BSR to the network, (ii) the UL-SCH resource is a configured resource, and (iii) the LCID is associated with the logicalChannelSR-Mask parameter, and in response to determining that (i) the UL-SCH is available for transmitting the BSR to the network, (ii) the UL-SCH resource is a configured resource, and (iii) the LCID is associated with the logicalChannelSR-Mask parameter, transmitting the BSR to the network using the grant and canceling the pendency of the BSR.

In some implementations, the method can further include: determining that (i) the UL-SCH is available for transmitting the BSR to the network, (ii) the UL-SCH resource is a configured resource, and (iii) the LCID is not associated with the logicalChannelSR-Mask parameter, and in response to determining that (i) the UL-SCH is available for transmitting the BSR to the network, (ii) the UL-SCH resource is a configured resource, and (iii) the LCID is not associated with the logicalChannelSR-Mask parameter, transmitting the BSR to the network using the grant.

In some implementations, the method can further include: subsequent to transmitting the BSR to the network, determining whether at least a portion of the data is pending transmission of the network, and in response to determining that no portion of the data is pending transmission to the network, canceling the pendency of the BSR.

In some implementations, the method can further include: subsequent to transmitting the BSR to the network, determining whether at least a portion of the data is pending transmission of the network, and
in response to determining that at least a portion of the data is pending transmission to the network, starting a SR periodicity timer and maintaining a pendency of the BSR.

In some implementations, the method can further include: responsive to determining that the SR periodicity timer has expired and the BSR is pending, transmitting the SR to the network.

In some implementations, the method can further include: in response to determining that at least the portion of the data is pending transmission to the network, starting a SR prohibit timer, and responsive to determining that both the SR periodicity timer and the SR prohibit timer have expired and the BSR is pending, transmitting the SR to the network.

In some implementations, the method can further include: determining that (i) the UL-SCH is not available for transmitting the BSR to the network, and (ii) the LCID is not associated with the logicalChannelSR-Mask parameter, and in response to determining that (i) the UL-SCH is not available for transmitting the BSR to the network, and (ii) the LCID is not associated with the logicalChannelSR-Mask parameter, transmitting the SR to the network.

In some implementations, the method can further include: determining that (i) the UL-SCH is not available for transmitting the BSR to the network, and (ii) the LCID is associated with the logicalChannelSR-Mask parameter, and in response to determining that (i) the UL-SCH is not available for transmitting the BSR to the network, and (ii) the LCID is associated with the logicalChannelSR-Mask parameter, canceling the pendency of the BSR.

In some implementations, the method can further include: in response to determining that the UL-SCH is not available for transmitting the BSR to the network and determining that the LCID is associated with the logicalChannelSR-Mask parameter, refraining from transmitting the BSR corresponding to the data to the SR to the network.

In some implementations, determining whether the UL-SCH resource is available for transmitting the BSR to the network can include determining whether the grant associated with the UL-SCH has a transport block size that is greater than a size of the BSR.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network.

FIG. 2 illustrates a flowchart of an example method for selectively transmitting Buffer Status Reports (BSRs) and/or Scheduling Requests (SRs).

FIG. 3 illustrates a flowchart of another example method for selectively transmitting BSRs and/or SRs.

FIG. 4 illustrates an example user equipment (UE).

FIG. 5 illustrates an example access node.

### DETAILED DESCRIPTION

This disclosure describes techniques for selectively transmitting Buffer Status Reports (BSRs) on a wireless network in the presence of configured uplink (UL) resources, such as semi-persistent scheduled UL grants in Long Term Evolution (LTE) and Configured Grants Type 1 and Type in Fifth Generation (5G) New Radio (NR).

In general, a user equipment (UE) can transmit data to and/or receive data from a wireless network using a Configured Grant process, whereby the wireless network (e.g., via an access node such as a base station in the radio access network, RAN) allocates resources to the UE for data transmission and/or data reception.

As an example, a UE can send a request to the wireless network for resources to transmit data (e.g., a Scheduling Request). In response, the wireless network can allocate resources to the UE based network conditions and/or other factors, and signal the allocated UL resources to the UE, such as by signaling parameters such as time-frequency resources, modulation schemes, coding rate, and/or other parameters. In turn, the UE can transmit the data using the allocated resource (e.g., including Configured Grant or dynamically allocated resources), in accordance with the signaled parameters.

In some implementations, a UE can also selectively transmit a Buffer Status Report (BSR) to the wireless network to facilitate the transmission of data. In general, the BSR provides a mechanism for the UE to inform the wireless network about the amount of data that the UE has in its buffer and is awaiting transmission to the wireless network. Based on the BSR, the wireless network can make an informed decision regarding uplink scheduling and resource allocation, such that the wireless network can better manage overall system capacity and facilitate the transmission of data in a timely manner. In some implementations, a UE can attempt to transmit a BSR to the network (e.g., “trigger” a BSR) based on various factors, such as the amount of data in the UE's buffer and/or a BSR timer.

As described in further detail below, the UE can be configured with mechanisms to selectively transmit BSRs and/or SRs to the network to facilitate the timely transmission of data. In some implementations, the techniques described herein can be beneficial in reducing data stall associated with uplink transmissions (e.g., whereby data is buffered by the UE for an extended period of time prior to transmission to the wireless network). These techniques may be particularly beneficial in the context of transmitting high priority and/or time-sensitive data, such as data associated with voice calls, videos calls, and/or interactive live content feeds.

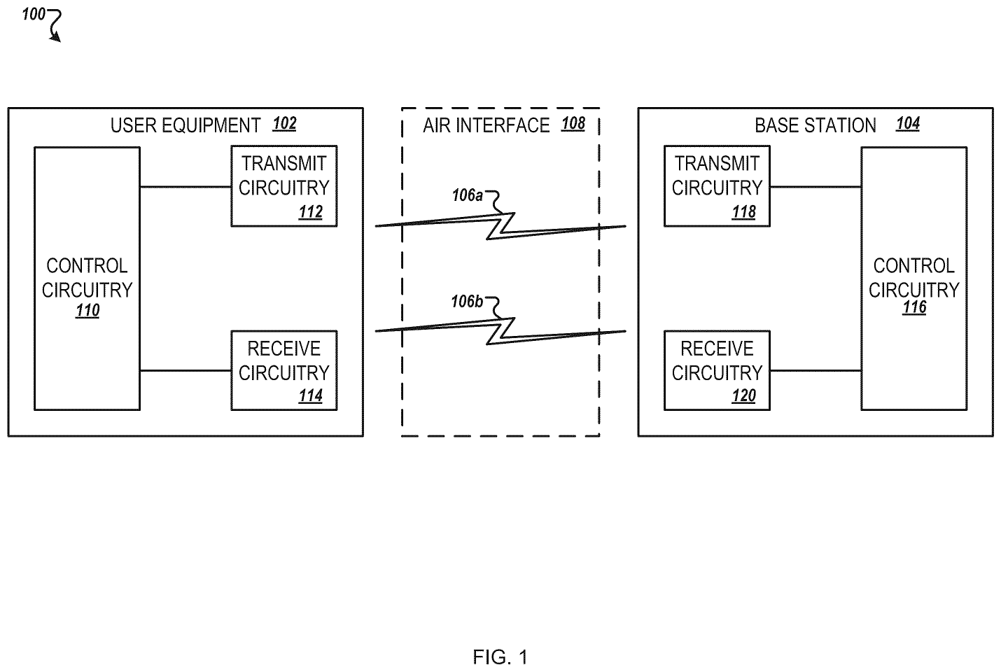

FIG. 1 illustrates a wireless network 100. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 is a Standalone (SA) network, e.g., that incorporates Fifth Generation (5G) New Radio (NR). In some other implementations, the wireless network 100 is a Non-Standalone (NSA) network that incorporates Long Term Evolution (LTE) and 5G NR. In these implementations, the wireless network 100 may be a E-UTRA (Evolved Universal Terrestrial Radio Access)-NR Dual Connectivity (EN-DC) network, or an NR-EUTRA Dual Connectivity (NE-DC) network. Furthermore, wireless networks implementing one or more other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For instance, the control circuitry 110 can be adapted or configured to cause the UE 102 to selectively transmit a BSR and/or a SR to a wireless network, depending on the context (e.g., as discussed further detail below).

The transmit circuitry 112 can perform various operations described in this specification. For example, the transmit circuitry 112 can transmit data (e.g., in the form of wireless signals) to the base station 104. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM), and in some implementations, along with carrier aggregation. The transmit circuitry 112 may be configured to receive block data from the control circuitry 110 for transmission on the air interface 1108.

The receive circuitry 114 can perform various operations described in this specification. For instance, the receive circuitry 114 can receive data (e.g., in the form of wireless signals) from the base station 104. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell (e.g., a satellite), or a legacy RAN, such as a UTRAN. As used herein, the term “5G RAN” or the like may refer to the base station 104 that operates in an NR wireless network 100, and the term “E-UTRAN” or the like may refer to a base station 104 that operates in an LTE wireless network 100. The UE 102 utilizes connections (or channels) 106A, 106B, each of which includes a physical communications interface or layer. In some implementations, the base station 104 may be a 5G radio access network (RAN),

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, Advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

In some cases, a UE may experience data stall when transmitting data to a wireless network. Data stall can refer, for example, to situations in which data is buffered by the UE for an extended period of time prior to transmission to the wireless network (e.g., due to network congestion, poor link quality, etc.). Data stall can be particularly undesirable when transmitting high priority and/or time-sensitive data, such as data associated with voice calls, videos calls, and/or interactive live content feeds.

In some implementations, a UE can mitigate data stall by triggering a BSR and requesting an uplink grant from the wireless network (e.g., by transmitting a SR to the wireless network to request resources for transmitting the data). For instance, in some implementations, the UE can selectively trigger and/or suspend a SR based on the availability of Uplink Shared Channel (UL-SCH) resources including configured grant resources, such as Configured Grant Type 1 and Type 2 (e.g., in 5G NR) and Uplink Semi-Persistent Scheduling (UL SPS) (e.g., in LTE).

As an example, when transmitting data associated with a particular Logical Channel Identifier (LCID), a UE can trigger a SR in the presence of available Configured Grant resources, if logicalChannelSR-mask is not set up for the LCID (e.g., the parameter logicalChannelSR-mask is set to false). In general, the parameter logicalChannelSR-mask controls the triggering of SRs for a specific logical channel (e.g., the logical channel specified by the LCID), and indicates whether the UE can send an SR for a logical channel when there is data in the buffer. In some implementations, logicalChannelSR-mask is not set up for the LCIDs that are associated with high priority and/or time-sensitive uplink data. In at least some implementations, the LCID is considered as being associated with a logicalChannelSR-mask parameter if the logicalChannelSR-mask parameter for that LCID is true, and as not being associated with a logicalChannelSR-mask parameter if the logicalChannelSR-mask parameter for that LCID is false.

This configuration can be beneficial, for example, in ensuring that the UE does not need to rely on already available Configured Grants to transmit data for high priority LCIDs, and can instead transmit SRs to the wireless network as soon as possible (e.g., to obtain new resources for transmitting the data sooner). In particular, waiting for a Configured Grant with large periodicity can add latency to the data transmission, and may not be suitable for some time-sensitive applications. Also, relying on sending BSR on the available Configured Resources depends on the UE implementation and may introduce processing delays associated with moving from the Physical Layer (PHY) to the Medium Access Control (MAC) layer. For example, if a wireless network deactivates Configured Grant via Downlink Control Information (DCI) and at the same time BSR is triggered, the MAC layer may not be aware of this change until the DCI is successfully decoded and information is transferred to MAC layer.

In some implementations, the UE can be configured such that there are no restrictions regarding the sending of a BSR on available configured grants. This means that, although the UE can transmit a SR to obtain a new DCI-based uplink grant (e.g., as described above), the UE may freely transmit the BSR on the available Configured Grants. In general, there is an advantage to allowing the use of Configured Grants to send a BSR. For example, if the transmission occasion is prior to the next DCI-based uplink grant, the BSR can be transmitted sooner, which can improve latency. However, this configuration may lead to data stall in some situations.

For example, according to the configuration described above, upon transmitting a BSR to the wireless network, the UE 102 can cancel any pending BSRs and start a timer (e.g., a BSR retransmission timer) to await a future grant to send the data. If no grant is allocated by the wireless network to the UE after sending the BSR, the UE can retransmit the BSR after the expiration of the timer.

In some implementations, allowing a BSR to be transmitted on a previously configured resource can result in data stall, particularly in situations where the wireless channel between the UE 102 and the wireless network is of poor quality and/or the wireless network is congested. For example, when connected to a congested wireless network with no Configured Resources, the UE 102 may repeatedly transmit SRs to the wireless network without success. Further, after a threshold number of unsuccessful SRs (e.g., after a configured maximum number of SR attempts is reached), the UE may start a Random Access Channel (RACH) process to re-establish the connection with the wireless network. Further, if the RACH process is unsuccessful, the UE 102 may determine a Radio Link Failure (RLF), and can re-attempt to connect on another cell of the wireless network (e.g., a cell having a higher quality wireless channel), if available. However, when there is an available Configured Resource with which to send the BSR, it is likely that the SR counter will not reach the threshold number of unsuccessful attempts, as the pending BSR is canceled each time the BSR is transmitted (or re-transmitted) on the Configured Grant slot (e.g., thereby resetting the SR counter). Accordingly, the UE 102 may repeatedly attempt to transmit a SR to the wireless network for an extended period of time, which can cause data stall and ultimately a call drop e.g. on a voice call

Further, a BSR that is transmitted on a Configured Grant is not guaranteed to be decoded by the wireless network, particularly if the Configured Grant parameters are no longer suitable for the current UE channel conditions and/or if a Configured Grant deactivation DCI was not decoded successfully by the UE. For instance, Configured Grant and/or SPS parameters (e.g., Modulation and Coding Scheme [MCS] and Resource Blocks [RBs]), may have been preconfigured at a time when the UE channel conditions were better, and those parameters may no longer be suitable when the UE channel conditions have deteriorated. Further, in a poor quality channel condition, the UE 102 may miss the deactivation DCI for configured grants, or the network may not receive UL SPS grants and may deduce that the UL SPS was implicitly released by UE Further still, the UE 102 may transmit a BSR on a Configured Grant that is no longer being monitored by the wireless network.

To mitigate data stall, the UE 102 can be configured to selectively transmit BSRs and/or SRs in a particular manner, based on the context. For instance, for an LCID in which logicalChannelSR-mask is not set up (e.g., the parameter logicalChannelSR-mask is false), a UE 102 can selectively transmit a BSR to the wireless network using a Configured Grant, cancel a pendency of the BSR, and/or transmit a SR to the wireless network.

As an example, if (i) a BSR is pending and has not been canceled and (ii) there are no available DCI-based UL-SCH resources, the UE 102 can trigger an SR (e.g., transmit an SR to the wireless network to transmit uplink data associated with the LCID).

Further, if a UL-SCH resource is available, the UE 102 can transmit the BSR on the earliest grant that is sufficiently large to fit (i) the entirety of the BSR or (ii) the entirety of the pending data associated with the LCID without the BSR. The earliest grant can be a Configured Grant resource or Dynamic Grant resource.

Further, the UE 102 can be configured to perform the following operations if the BSR is transmitted to the wireless network using a Configured Grant resource (e.g., UL SPS on LTE, or Configured Grant Type 1 or Type 2 on 5G NR).

First, if logicalChannelSR-mask is not set up for the LCID (e.g., the parameter logicalChannelSR-mask is false), the UE 102 can maintain the pendency of the BSR (e.g., refrain from canceling the BSR) and start a SR periodicity timer. Further, if a SR prohibit timer is configured (e.g., by the wireless network), the UE 102 can also start the SR prohibit timer.

Second, if the SR prohibit timer and the SR periodicity timer have expired and the BSR is still pending, the UE 102 can trigger a SR.

Further, if the BSR was sent on a DCI-based uplink grant or all available data for the triggered LCID has been sent, the UE 102 can cancel the pending BSR.

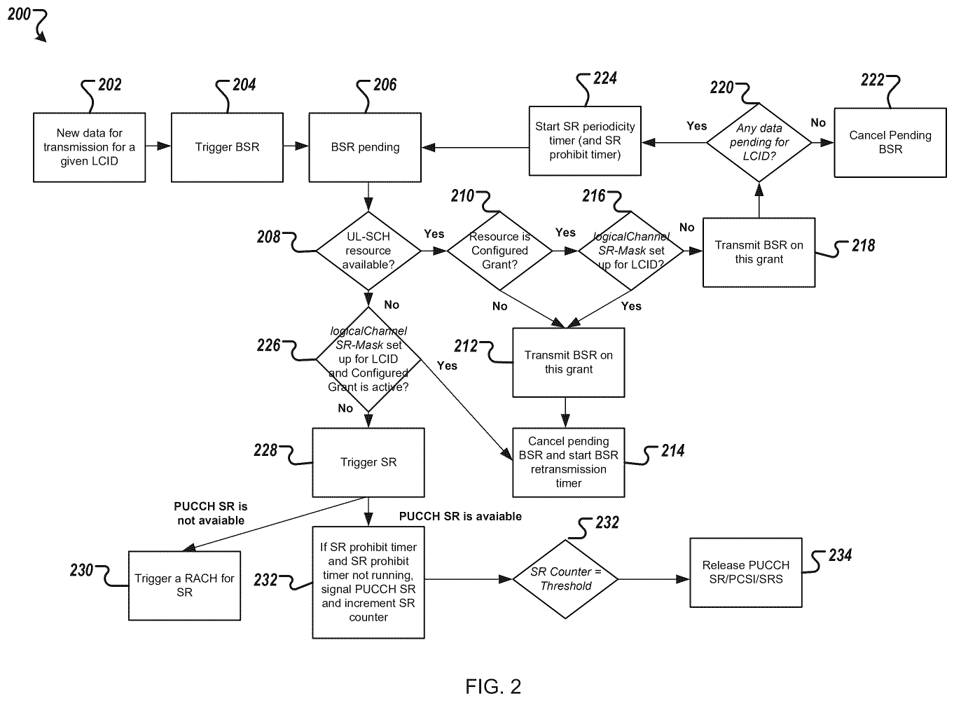

FIG. 2 shows a flowchart of an example method 200 for selectively transmitting Buffer Status Reports (BSRs) and/or Scheduling Requests (SRs). For clarity of presentation, the description that follows generally describes method 200 in the context of the other figures in this description. For example, in some implementations, the method 200 is performed by a UE, e.g., the UE 102, in accordance with the configuration described in the preceding section. It will be understood that method 200 can be performed, for example, by any suitable system, environment, software, hardware, or a combination of systems, environments, software, and hardware, as appropriate. In some implementations, various steps of method 200 can be run in parallel, in combination, in loops, or in any order.

According to the process 200, the UE 102 receives data for transmission to the wireless network (202). The data is associated with a particular LCID.

The UE 102 triggers a BSR for the data (e.g., to indicate to the wireless network the presence of buffered uplink data for transmission) (204), and sets the BSR to a pending state (206).

The UE 102 determines whether a UL-SCH resource is available (208).

If a UL-SCH resource is available, the UE determines whether the UL-SCH resource is a Configured Grant resource (210).

If the UL-SCH resource is not a Configured Grant resource, the UE 102 transmits the BSR on the UL-SCH resource (212). Further, the UE 102 cancels the pending BSR and starts a BSR retransmission timer (214).

However, if the UL-SCH resource is a Configured Grant resource, the UE 102 determines whether logicalChannelSR-mask is set up for the LCID (e.g., whether the parameter logicalChannelSR-mask is false) (216).

If logicalChannelSR-mask is set up for the LCID (e.g., the parameter logicalChannelSR-mask is true), the UE 102 transmits the BSR on the UL-SCH resource (212), and cancels the pending BSR and starts the BSR retransmission timer (214).

However, if logicalChannelSR-mask is not set up for the LCID (e.g., the parameter logicalChannelSR-mask is false), the UE 102 transmits the BSR on the grant (218).

Further, the UE 102 determines whether any data is pending transmission for the LCID (220). If no data is pending transmission for the LCID, the UE 102 cancels the pending BSR (222).

If at least some data is pending transmission for the LCID, the UE 102 starts a SR periodicity timer (224). If a SR prohibit timer is configured, the UE 102 can also start the SR prohibit timer. The UE 102 also maintains the pendency of the BSR (206), and re-performs one or more operations of the process 200.

Alternatively, if a UL-SCH resource is not available, the UE determines whether logicalChannelSR-mask is set up for the LCID (e.g., whether the parameter logicalChannelSR-mask is false) and whether Configured Grant is active (226).

If logicalChannelSR-mask is set up for the LCID (e.g., the parameter logicalChannelSR-mask is true) and Configured Grant is active, the UE 102 cancels the pending BSR (214). That is, the UE 102 neither transmits the BSR nor transmits a SR to the wireless network.

However, if logicalChannelSR-mask is not set up for the LCID (e.g., the parameter logicalChannelSR-mask is false) and/or Configured grant is not active, the UE 102 triggers an SR (228).

Further, if a Physical Uplink Control Channel (PUCCH) SR is not available, the UE 102 triggers a RACH process for the SR (230).

However, if a PUCCH SR is available, the UE 102 determines whether the SR periodicity timer (and the SR prohibit timer, if configured) are still running or have expired. If the SR periodicity timer (and the SR prohibit timer, if configured) is not running, the UE 102 signals the PUCCH SR and increases a SR counter (232).

If the SR counter is equal to a threshold number (e.g., after a threshold number of SR attempts have been reached), the UE 102 releases the PUCCH SR, Periodic Channel State Information (P-CSI), and a (Sounding Reference Signal (SRS) (234).

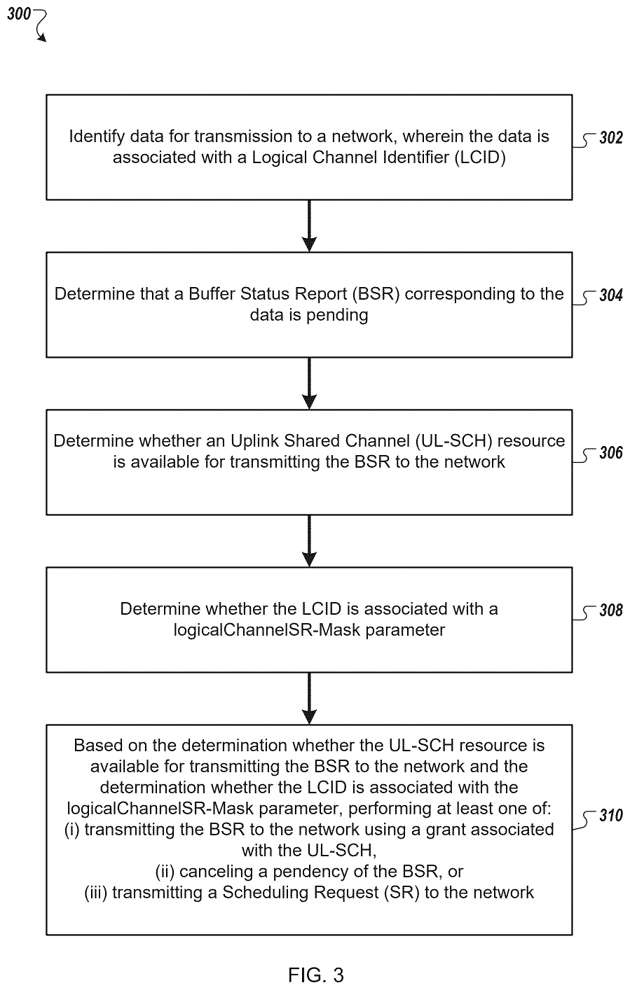

FIG. 3 illustrates a flowchart of another example method 300 for selectively transmitting BSRs and/or SRs, according to some implementations. For clarity of presentation, the description that follows generally describes method 300 in the context of the other figures in this description. For example, method 300 can be performed by the UE 102 of FIG. 1. It will be understood that method 300 can be performed, for example, by any suitable system, environment, software, hardware, or a combination of systems, environments, software, and hardware, as appropriate. In some implementations, various steps of method 300 can be run in parallel, in combination, in loops, or in any order.

According to the method 300, a device (e.g., a UE, baseband processor of the UE, etc.) identifies data for transmission to a network (302). The data is associated with a Logical Channel Identifier (LCID).

The device determines that a Buffer Status Report (BSR) corresponding to the data is pending (304).

In response to determining that the BSR corresponding to the data is pending, the device performs the following operations.

The device determines whether an Uplink Shared Channel (UL-SCH) resource is available for transmitting the BSR to the network (306).

Further, the device determines whether the LCID is associated with a logicalChannelSR-Mask parameter (308).

Further, based on the determination whether the UL-SCH resource is available for transmitting the BSR to the network and the determination whether the LCID is associated with the logicalChannelSR-Mask parameter, the device performing at least one of: (i) transmitting the BSR to the network using a grant associated with the UL-SCH, (ii) canceling a pendency of the BSR, or (iii) transmitting a Scheduling Request (SR) to the network (310).

Implementations first aspect can include or more of the following features.

In some implementations, according to the method 300, the device determines that (i) the UL-SCH is available for transmitting the BSR to the network and (ii) the UL-SCH resource is not a configured resource. Further, in response to these determines, the device transmits the BSR to the network using the grant and cancels the pendency of the BSR.

In some implementations, according to the method 300, the device determines that (i) the UL-SCH is available for transmitting the BSR to the network, (ii) the UL-SCH resource is a configured resource, and (iii) the LCID is associated with the logicalChannelSR-Mask parameter. Further, in response to these determinations, the device transmits the BSR to the network using the grant and cancels the pendency of the BSR.

In some implementations, according to the method 300, the device determines that (i) the UL-SCH is available for transmitting the BSR to the network, (ii) the UL-SCH resource is a configured resource, and (iii) the LCID is not associated with the logicalChannelSR-Mask parameter. Further, in response to these determinations, the device, transmits the BSR to the network using the grant.

In some implementations, subsequent to transmitting the BSR to the network, the device determines whether at least a portion of the data is pending transmission of the network, and in response to determining that no portion of the data is pending transmission to the network, cancels the pendency of the BSR.

In some implementations, subsequent to transmitting the BSR to the network, the device determines whether at least a portion of the data is pending transmission of the network, and in response to determining that at least a portion of the data is pending transmission to the network, starts a SR periodicity timer and maintaining a pendency of the BSR.

In some implementations, responsive to determining that the SR periodicity timer has expired and the BSR is pending, the device transmits the SR to the network.

In some implementations, in response to determining that at least the portion of the data is pending transmission to the network, the device starts a SR prohibit timer. Further, in response to determining that both the SR periodicity timer and the SR prohibit timer have expired and the BSR is pending, the device transmits the SR to the network.

In some implementations, according to the method 300, the device determines that (i) the UL-SCH is not available for transmitting the BSR to the network, and (ii) the LCID is not associated with the logicalChannelSR-Mask parameter. Further, in response to these determinations, the device transmits the SR to the network.

In some implementations, according to the method 300, the device determines that (i) the UL-SCH is not available for transmitting the BSR to the network, and (ii) the LCID is associated with the logicalChannelSR-Mask parameter. Further, in response to these determinations, the device cancels the pendency of the BSR.

In some implementations, in response to determining that the UL-SCH is not available for transmitting the BSR to the network and determining that the LCID is associated with the logicalChannelSR-Mask parameter, the device refrains from transmitting the BSR corresponding to the data to the SR to the network.

In some implementations, determining whether the UL-SCH resource is available for transmitting the BSR to the network can include determining whether the grant associated with the UL-SCH has a transport block size that is greater than a size of the BSR.

The example method 300 shown in FIG. 3 can be modified or reconfigured to include additional, fewer, or different steps (not shown in FIG. 3), which can be performed in the order shown or in a different order.

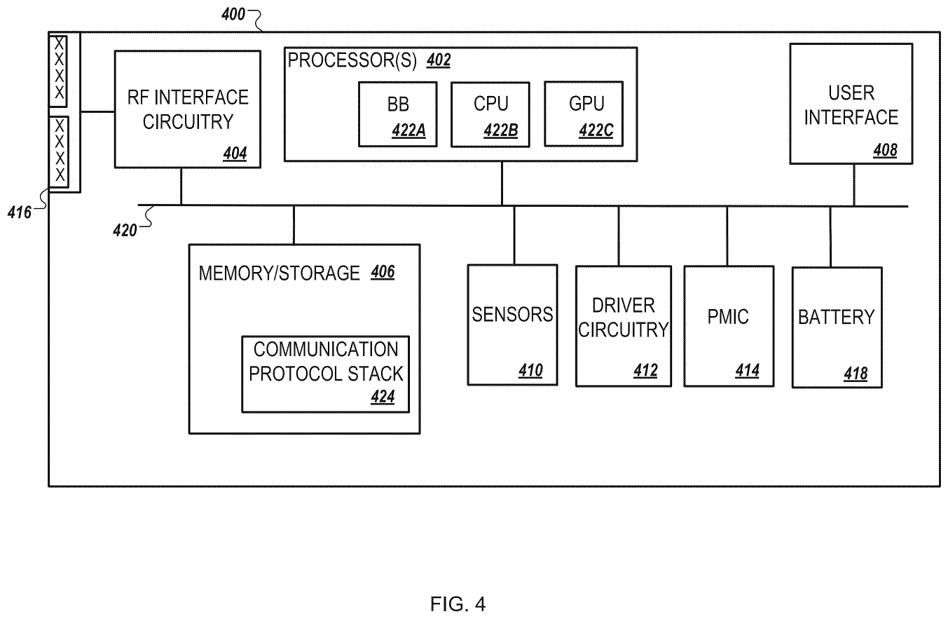

FIG. 4 illustrates an example UE 400. The UE 400 may be similar to and substantially interchangeable with UE 102 of FIG. 1.

The UE 400 may be any mobile or non-mobile computing device, such as, for example, a mobile phone, computer, tablet, industrial wireless sensors, video device (for example, cameras, video cameras, etc.), wearable devices (for example, a smart watch), relaxed-IoT devices, etc.

The UE 400 may include any/all of processor 402, RF interface circuitry 404, memory/storage 406, user interface 408, sensors 410, driver circuitry 412, power management integrated circuit (PMIC) 414, one or more antenna(s) 416, and battery 418. The components of the UE 400 may be implemented as integrated circuits (ICs), portions thereof, discrete electronic devices, or other modules, logic, hardware, software, firmware, or a combination thereof. The block diagram of FIG. 4 is intended to show a high-level view of some of the components of the UE 400. However, some of the components shown may be omitted, additional components may be present, and a different arrangement of the components shown may occur in other implementations.

The components of the UE 400 may be coupled with various other components over one or more interconnects 420, which may represent any type of interface, input/output, bus (local, system, or expansion), transmission line, trace, optical connection, etc., that allows various circuit components (on common or different chips or chipsets) to interact with one another.

The processor 402 may include one or more processors. For example, the processor 402 may include processor circuitry such as, for example, baseband processor circuitry (BB) 422A, central processor unit circuitry (CPU) 422B, and graphics processor unit circuitry (GPU) 422C. The processor 402 may include any type of circuitry or processor circuitry that executes or otherwise operates computer-executable instructions, such as program code, software modules, or functional processes from memory/storage 406 to cause the UE 400 to perform operations as described herein.

In some implementations, the baseband processor circuitry 422A may access a communication protocol stack 424 in the memory/storage 406 to communicate over a 3GPP compatible network. In general, the baseband processor circuitry 422A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 404. The baseband processor circuitry 422A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 406 may include one or more non-transitory, computer-readable media that includes instructions (for example, communication protocol stack 424) that may be executed by the processor 402 to cause the UE 400 to perform various operations described herein. The memory/storage 406 include any type of volatile or non-volatile memory that may be distributed throughout the UE 400. In some implementations, some of the memory/storage 406 may be located on the processor 402 itself (for example, L1 and L2 cache), while other memory/storage 406 is external to the processor 402 but accessible thereto via a memory interface. The memory/storage 406 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 404 may include transceiver circuitry and radio frequency front module (RFEM) that allows the UE 400 to communicate with other devices over a radio access network. The RF interface circuitry 404 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 416 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 416. In various implementations, the RF interface circuitry 404 may be configured to transmit/receive signals in a manner compatible with NR access technologies.

The antenna(s) 416 may include one or more antenna elements to convert electrical signals into radio waves to travel through the air and to convert received radio waves over the air into electrical signals. In some implementations, the antenna elements may be arranged into one or more antenna panels. The antenna(s) 416 may have antenna panels that are omnidirectional, directional, or a combination thereof, to enable beamforming and multiple input, multiple output communications. The antenna(s) 416 may include any/all of microstrip antennas, printed antennas fabricated on the surface of one or more printed circuit boards, patch antennas, phased array antennas, etc. The antenna(s) 416 may have one or more panels designed for one or more specific frequency bands, such as bands in FR1 or FR2.

The user interface 408 includes various input/output (I/O) devices designed to enable user interaction with the UE 400. The user interface 408 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 400.

The sensors 410 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 412 may include software and hardware elements that operate to control particular devices that are embedded in the UE 400, attached to the UE 400, or otherwise communicatively coupled with the UE 400. The driver circuitry 412 may include individual drivers allowing other components to interact with or control various input/output (I/O) devices that may be present within, or connected to, the UE 400. For example, driver circuitry 412 may include a display driver to control and allow access to a display device, a touchscreen driver to control and allow access to a touchscreen interface, sensor drivers to obtain sensor readings of sensors 410 and control and allow access to sensors 410, drivers to obtain actuator positions of electro-mechanic components or control and allow access to the electro-mechanic components, a camera driver to control and allow access to an embedded image capture device, audio drivers to control and allow access to one or more audio devices.

The PMIC 414 may manage power provided to various components of the UE 400. In particular, with respect to the processor 402, the PMIC 414 may control power-source selection, voltage scaling, battery charging, or DC-to-DC conversion.

In some implementations, the PMIC 414 may control, or otherwise be part of, various power saving mechanisms of the UE 400. A battery 418 may power the UE 400, although in some examples the UE 400 may be mounted deployed in a fixed location, and may have a power supply coupled to an electrical grid. The battery 418 may be a lithium ion battery, a metal-air battery, such as a zinc-air battery, an aluminum-air battery, a lithium-air battery, and the like. In some implementations, such as in vehicle-based applications, the battery 418 may be a typical lead-acid automotive battery.

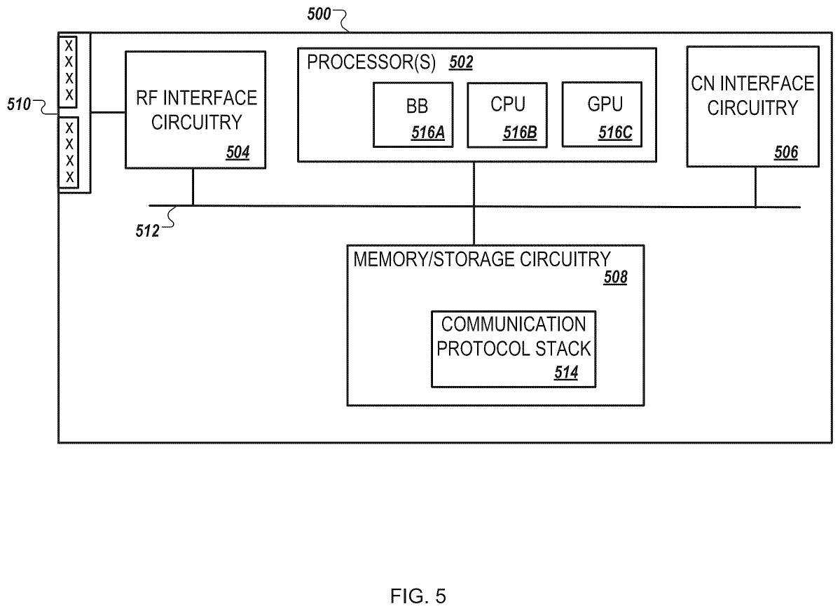

FIG. 5 illustrates an example access node 500 (e.g., a base station or gNB), according to some implementations. The access node 500 may be similar to and substantially interchangeable with base station 104. The access node 500 may include one or more of processor 502, RF interface circuitry 504, core network (CN) interface circuitry 506, memory/storage circuitry 508, and one or more antenna(s) 510. The processor 502 may include any type of circuitry or processor circuitry that executes or otherwise operates computer-executable instructions, such as program code, software modules, or functional processes from memory/storage circuitry 508 to cause the access node 500 to perform operations as described herein.

The components of the access node 500 may be coupled with various other components over one or more interconnects 512. The processor 502, RF interface circuitry 504, memory/storage circuitry 508 (including communication protocol stack 514), antenna(s) 510, and interconnects 512 may be similar to like-named elements shown and described with respect to FIG. 4. For example, the processor 502 may include processor circuitry such as, for example, baseband processor circuitry (BB) 516A, central processor unit circuitry (CPU) 516B, and graphics processor unit circuitry (GPU) 516C.

The CN interface circuitry 506 may provide connectivity to a core network, for example, a 5th Generation Core network (5GC) using a 5GC-compatible network interface protocol such as carrier Ethernet protocols, or some other suitable protocol. Network connectivity may be provided to/from the access node 500 via a fiber optic or wireless backhaul. The CN interface circuitry 506 may include one or more dedicated processors or FPGAs to communicate using one or more of the aforementioned protocols. In some implementations, the CN interface circuitry 506 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TR×Ps or TRPs, and so forth, and can include ground stations (e.g., terrestrial access points) or satellite stations providing coverage within a geographic area (e.g., a cell). As used herein, the term “NG RAN node” or the like may refer to an access node 500 that operates in an NR or 5G system (for example, a gNB), and the term “E-UTRAN node” or the like may refer to an access node 500 that operates in an LTE or 4G system (e.g., an eNB). According to various implementations, the access node 500 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 500 may be implemented as one or more software entities running on server computers as part of a virtual network, which may be referred to as a CRAN and/or a virtual baseband unit pool (vBBUP). In V2X scenarios, the access node 500 may be or act as a “Road Side Unit. ” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to. ” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method comprising:
identifying data for transmission to a network, wherein the data is associated with a Logical Channel Identifier (LCID);
determining that a Buffer Status Report (BSR) corresponding to the data is pending; and
in response to determining that the BSR corresponding to the data is pending:
determining whether an Uplink Shared Channel (UL-SCH) resource is available for transmitting the BSR to the network;
determining whether the LCID is associated with a logicalChannelSR-Mask parameter; and
based on the determination whether the UL-SCH resource is available for transmitting the BSR to the network and the determination whether the LCID is associated with the logicalChannelSR-Mask parameter, performing at least one of:
transmitting the BSR to the network using a grant associated with the UL-SCH,
canceling a pendency of the BSR, or
transmitting a Scheduling Request (SR) to the network.

2. The method of claim 1, further comprising:
determining that (i) the UL-SCH is available for transmitting the BSR to the network and (ii) the UL-SCH resource is not a configured resource; and
in response to determining that (i) the UL-SCH is available for transmitting the BSR to the network and (ii) the UL-SCH resource is not a configured resource, transmitting the BSR to the network using the grant and canceling the pendency of the BSR.

3. The method of claim 1, further comprising:
determining that (i) the UL-SCH is available for transmitting the BSR to the network, (ii) the UL-SCH resource is a configured resource, and (iii) the LCID is associated with the logicalChannelSR-Mask parameter, and
in response to determining that (i) the UL-SCH is available for transmitting the BSR to the network, (ii) the UL-SCH resource is a configured resource, and (iii) the LCID is associated with the logicalChannelSR-Mask parameter, transmitting the BSR to the network using the grant and canceling the pendency of the BSR.

4. The method of claim 1, further comprising:
determining that (i) the UL-SCH is available for transmitting the BSR to the network, (ii) the UL-SCH resource is a configured resource, and (iii) the LCID is not associated with the logicalChannelSR-Mask parameter, and
in response to determining that (i) the UL-SCH is available for transmitting the BSR to the network, (ii) the UL-SCH resource is a configured resource, and (iii) the LCID is not associated with the logicalChannelSR-Mask parameter, transmitting the BSR to the network using the grant.

5. The method of claim 4, further comprising:
subsequent to transmitting the BSR to the network, determining whether at least a portion of the data is pending transmission of the network, and
in response to determining that no portion of the data is pending transmission to the network, canceling the pendency of the BSR.

6. The method of claim 4, further comprising:
subsequent to transmitting the BSR to the network, determining whether at least a portion of the data is pending transmission of the network, and
in response to determining that at least a portion of the data is pending transmission to the network, starting a SR periodicity timer and maintaining a pendency of the BSR.

7. The method of claim 6, further comprising:
responsive to determining that the SR periodicity timer has expired and the BSR is pending, transmitting the SR to the network.

8. The method of claim 6, further comprising:
in response to determining that at least the portion of the data is pending transmission to the network, starting a SR prohibit timer, and
responsive to determining that both the SR periodicity timer and the SR prohibit timer have expired and the BSR is pending, transmitting the SR to the network.

9. The method of claim 1, further comprising:
determining that (i) the UL-SCH is not available for transmitting the BSR to the network, and (ii) the LCID is not associated with the logicalChannelSR-Mask parameter, and
in response to determining that (i) the UL-SCH is not available for transmitting the BSR to the network, and (ii) the LCID is not associated with the logicalChannelSR-Mask parameter, transmitting the SR to the network.

10. The method of claim 1, further comprising:
determining that (i) the UL-SCH is not available for transmitting the BSR to the network, and
(ii) the LCID is associated with the logicalChannelSR-Mask parameter, and
in response to determining that (i) the UL-SCH is not available for transmitting the BSR to the network, and (ii) the LCID is associated with the logicalChannelSR-Mask parameter, calceing the pendency of the BSR.

11. The method of claim 10, further comprising:
in response to determining that the UL-SCH is not available for transmitting the BSR to the network and determining that the LCID is associated with the logicalChannelSR-Mask parameter, refraining from transmitting the BSR corresponding to the data to the SR to the network.

12. The method of claim 1, wherein determining whether the UL-SCH resource is available for transmitting the BSR to the network comprises:
determining whether the grant associated with the UL-SCH has a transport block size that is greater than a size of the BSR.

13. (canceled)

14. (canceled)

15. A user equipment (UE) base station comprising one or more processors configured to perform operations comprising:
identifying data for transmission to a network, wherein the data is associated with a Logical Channel Identifier (LCID);
determining that a Buffer Status Report (BSR) corresponding to the data is pending; and
in response to determining that the BSR corresponding to the data is pending:
determining whether an Uplink Shared Channel (UL-SCH) resource is available for transmitting the BSR to the network;
determining whether the LCID is associated with a logicalChannelSR-Mask parameter; and
based on the determination whether the UL-SCH resource is available for transmitting the BSR to the network and the determination whether the LCID is associated with the logicalChannelSR-Mask parameter, performing at least one of:
transmitting the BSR to the network using a grant associated with the UL-SCH,
canceling a pendency of the BSR, or
transmitting a Scheduling Request (SR) to the network.

16. An apparatus comprising one or more baseband processors configured to perform operations comprising:
identifying data for transmission to a network, wherein the data is associated with a Logical Channel Identifier (LCID);
determining that a Buffer Status Report (BSR) corresponding to the data is pending; and in response to determining that the BSR corresponding to the data is pending:
determining whether an Uplink Shared Channel (UL-SCH) resource is available for transmitting the BSR to the network;
determining whether the LCID is associated with a logicalChannelSR-Mask parameter; and
based on the determination whether the UL-SCH resource is available for transmitting the BSR to the network and the determination whether the LCID is associated with the logicalChannelSR-Mask parameter, performing at least one of:
transmitting the BSR to the network using a grant associated with the UL-SCH,
canceling a pendency of the BSR, or
transmitting a Scheduling Request (SR) to the network.

17. The apparatus of claim 16, the operations further comprising:
determining that (i) the UL-SCH is available for transmitting the BSR to the network and (ii) the UL-SCH resource is not a configured resource; and
in response to determining that (i) the UL-SCH is available for transmitting the BSR to the network and (ii) the UL-SCH resource is not a configured resource, transmitting the BSR to the network using the grant and canceling the pendency of the BSR.

18. The apparatus of claim 16, the operations further comprising:
determining that (i) the UL-SCH is available for transmitting the BSR to the network, (ii) the UL-SCH resource is a configured resource, and (iii) the LCID is associated with the logicalChannelSR-Mask parameter, and
in response to determining that (i) the UL-SCH is available for transmitting the BSR to the network, (ii) the UL-SCH resource is a configured resource, and (iii) the LCID is associated with the logicalChannelSR-Mask parameter, transmitting the BSR to the network using the grant and canceling the pendency of the BSR.

19. The apparatus of claim 16, the operations further comprising:
determining that (i) the UL-SCH is available for transmitting the BSR to the network, (ii) the UL-SCH resource is a configured resource, and (iii) the LCID is not associated with the logicalChannelSR-Mask parameter, and
in response to determining that (i) the UL-SCH is available for transmitting the BSR to the network, (ii) the UL-SCH resource is a configured resource, and (iii) the LCID is not associated with the logicalChannelSR-Mask parameter, transmitting the BSR to the network using the grant.

20. The apparatus of claim 16, the operations further comprising:
determining that (i) the UL-SCH is not available for transmitting the BSR to the network, and (ii) the LCID is not associated with the logicalChannelSR-Mask parameter, and
in response to determining that (i) the UL-SCH is not available for transmitting the BSR to the network, and (ii) the LCID is not associated with the logicalChannelSR-Mask parameter, transmitting the SR to the network.

21. The apparatus of claim 16, the operations further comprising:
determining that (i) the UL-SCH is not available for transmitting the BSR to the network, and (ii) the LCID is associated with the logicalChannelSR-Mask parameter, and
in response to determining that (i) the UL-SCH is not available for transmitting the BSR to the network, and (ii) the LCID is associated with the logicalChannelSR-Mask parameter, calceing the pendency of the BSR.
